(19) United States
(12) Patent Application Publication
(10) Pub. No.: US 2003/0157014 A1
(43) Pub. Date: Aug. 21, 2003

(54) Pyrolyzed hard carbon material, preparation and its applications

(76) Inventors: Qing Wang, Beijing (CN); Hong Li, Beijing (CN); Xuejie Huang, Beijing (CN); Liquan Chen, Beijing (CN)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/258,350

(22) PCT Filed: Apr. 24, 2001
(86) PCT No.: PCT/CN01/00613

(30) Foreign Application Priority Data
Apr. 27, 2000 (CN) 00106225.5

(51) Int. Cl. C01B 31/00

(52) U.S. Cl. 423/445 R

(57) ABSTRACT

A kind of pyrolyzed hard carbon material, preparation and its applications are involved in this patent. The particle of this material has spherical or ellipsoidal morphology with smooth surface. The average particle size is in the range of 0.05/100 microns and the coarseness is not more than 0.5% of the particle size. The BET specific surface area is from 1 to 4000 square meters per gram. The inner pore size of the material is distributed between 0.3 and 50 nanometers, and the values of Le and La are from 1 to 20 nanometers. The real density of the material is from 0.8 to 2.2 grams per cubic centimeter and the tap density is 0.35/1.5 grams per cubic centimeter. The preparation of the material can be described as follows: firstly the precursors are mixed with solvents for homogenous distribution systems, then the mixtures are put into autoclave for dewatering. ollowing with washing, filtrating, drying and high-temperature treatment, the hard carbon material is obtained. This kind of material has wide utilizations, especially in using as negative electrode materials for secondary lithium batteries.

### TECHNICAL FIELD

Carbonaceous material and its preparation process are introduced in this patent. Especially a kind of pyrolyzed hard carbon material, preparation and its applications are involved.

### BACKGROUND OF THE INVENTION

Based on their ability to be graphitized, carbonaceous materials are generally divided into soft carbon (graphitizable) and hard carbon (non-graphitizable). For example, the products of petroleum, coal, pitch, polyvinyl chloride and anthracene after carbonization belong to soft carbon, whereas those of cellulose, carbohydrates, furan resin, phenolic resin and PVDF are hard carbon. At elevated temperature, the precursors of soft carbon can melt into liquid state and polymerize. In light of surface tension, these polymerized intermediates form granular-like beads, which are insoluble in quinoline and called mesophase beads. The granular-like morphology cannot be changed during further carbonization or graphitization. However, the precursors of hard carbon cannot melt upon heat treatment due to the presence of large quantities of interconnection bonds; instead, the precursors directly carbonize via solid state without forming the spherical mesophase beads. The obtained graphene sheets are nonparallel interconnected. Even at very high temperature, it is difficult for the hard carbon to be graphitized. After high temperature heat treatment, the obtained hard carbon is generally consisted of interconnected graphene sheets stacking no more than twenty layers. The layer spacing is about 0.37 nm on average, and the diameter within one graphene layer is not more than 5 nm. There are still some non-graphite structures, such as sp³ carbon atoms within crystal structure. The disordered stacking of graphene layers gives rise to large quantities of cavities, and the formed micropores account for 20˜50 percent of the total volume. The interconnected structure cannot be easily removed even at carbon's sublimation temperature. Commonly, the products from direct carbonization via solid state still retain the morphology and texture of the precursors. Consequently, it is not easy to prepare spherical materials from hard carbon. The obtained products normally have irregular shape, non-uniform particle size, and low packing density, which cannot meet the practical demands in many fields.

### SUMMARY OF THE INVENTION

It is the objective of the present invention to overcome the difficulties in producing spherical hard carbon materials from existing precursors, which always have irregular morphology, non-uniform particle size and low packing density. To increase the packing density and surface smoothness of the products from solid-state carbonization, the present invention provides a method that requires simple technique, low cost and has the adaptability to mass production, through dewatering the precursors to form spherules in liquid state followed by pyrolyzing obtained intermediates. The present invention also provides a kind of pyrolyzed hard carbon material with spherical or ellipsoidal morphology, uniform particle size, high packing density, and its applications, especially in secondary lithium batteries.

### DETAILED DESCRIPTION OF THE INVENTION

The present invention is described as follows:

The pyrolyzed hard carbon in the present invention is a kind of spherule or ellipsoid with smooth surface, particle size of 0.05˜100 μm in diameter, and surface roughness not more than 0.5 percent of the particle size; the specific surface Brunauer-Emmett-Teller area (BET area) is between 1 and 4000 m²/g; the pore size of micropores and mesopores within the material is 0.3˜50 nm; the measured d₀₀₂ is 0.345˜0.45 nm and the values of Lc and La are both 1˜20 nm from X-ray diffraction (XRD) measurements; The real density is 0.8˜2.2 g/cm³ and tap density is 0.35˜1.5 g/cm³; The amount of elements besides to carbon is not more than 10 percent in weight within the material. In the present invention, hydrothermal (or using other solvents) method is used to dewater the precursor in liquid state and form spherules. The intermediates are further pyrolyzed at elevated temperatures, and hard carbon products can be finally obtained. The detailed preparation processes are as follows:

(1) Preparation of homogeneous dispersion system. The precursor for hard carbon synthesis, including glucose, sucrose, fructose, cellulose, starch or the mixture of any above precursors in random ratio, is mixed with water to form homogeneous dispersion system with a concentration of 0.05˜10 molar per liter; or another precursor for hard carbon synthesis, including phenolic resin, polyacrylonitrile, mixture of epoxy and solidifying reagent phthalic anhydride, or mixture of epoxy, polyformaldehyde and phenol, is mixed with regular organic solvents, such as ethanol, acetone, N,N-dimethylformamide, or the mixture of any above organic solvents in random ratio, to form homogeneous dispersion system with a concentration of 0.05˜10M. For the mixture of epoxy and phthalic anhydride, the content of epoxy should not be less than 25 percent in weight; and for the mixture of epoxy, polyformaldehyde and phenol, the content of epoxy should not be less than 25 percent in weight, the content of phenol should not be more than 10 percent in weight, and the rest is polyformaldehyde.

(2) Dewatering in liquid state. The homogeneous dispersion system prepared in step (1) is put into pressure vessel with a fill rate of 30˜95 percent; then the sealed pressure vessel is heated to a final temperature of 150˜300 degrees centigrade with a heating rate of 30˜600 degrees centigrade per hour. The mixture should be maintained at the final temperature for 0˜48 hours. Mechanical stirring is optional with a rotate speed of 0˜1500 rounds per minute.

(3) Washing and drying. After cooling to ambient temperature with a cooling rate of 1˜3000 degrees centigrade per hour, the intermediate is taken out from the pressure vessel and washed with water, ethanol and its aqueous solution at random concentration, then filtrated to the filtrates being transparent. Then the filtrated intermediate is dried at 50˜200 degrees centigrade to remove the water.

(4) High temperature carbonization. After drying, the intermediate is placed in furnace either under the protection of inert or hydrogen atmosphere with a flow rate of 0.5˜200 milliliter per minute, or under vacuum degree of 0.001˜380 mmHg; and the intermediate is carbonized with a heating rate of 30˜300 degrees centigrade per hour. After reaching the final temperature of 600˜3000 degrees centigrade, the intermediate is maintained at constant temperature for 0˜48 hours, and then cooled to ambient temperature with a cooling rate of 1˜3000 degrees centigrade per hour. Finally, we can obtain the spherical or ellipsoidal pyrolyzed hard carbon.

In addition, in order to improve the dispersibility of the product and to control the distribution of particle size, the present invention also includes adding 0˜5 molar per liter of organic additives into the homogeneous dispersion. These organic additives include: glycol, glycerol, tetraethylammonium hydroxide, n-Dipropylamine, tri-npropylamine, N,N-diethylethanamine, triethanolamine, dibutylamine, pivalic amine, dipentylamine, isopropylamine, tert-butylamine, ethylenediamine, N,N-dimethylbenzylamine, dicyclohexylamine, N,N-dimethylpropanolamine, tetrapropylamine, quaterary ammonium salt, choline, 2-methylpyridine, 3-methylpiperidine, 4-methylpiperidine or 2-imidazolinone.

Furthermore, in order to enhance the porosity of the product, activation reagents can be added in any step of steps (1), (3), or (4) in the present invention. The activation reagents include: zinc chloride, potassium sulfide, potassium sulfate, sodium sulfate, sodium sulfide, phosphoric acid, potassium hydroxide, sodium hydroxide or lithium hydroxide. The weight ratio of the additive to the precursor is 0.1˜10. Alternatively, the material can also be activated through gas activation process, of which either the protection gas is displaced by activation gas during or after step (4), or the activation gas flows together with protection gas during step (4). The activation gases include carbon dioxide, water vapor, air or oxygen, of which the flow rate is 0.5˜200 milliliters per minute.

Owing to the regular spherical or ellipsoidal appearance, uniform particle size distribution and high packing density, the spherical or ellipsoidal pyrolyzed hard carbon material in the present invention can be widely used in various fields, especially in secondary lithium batteries. When the hard carbon material of present invention is used as negative electrode material for secondary lithium batteries, since the surface area of the material is relatively small, the consumption of lithium to form the passivation layer during charge/discharge process is less. Though the inner surface of the material is large, the electrolyte cannot penetrate into the nanopores within the material. Consequently, the Coulombic efficiency of the battery is high. Meanwhile, the spherical surface structure of the material benefits the formation of stable passivation layer, thus satisfactory cyclic capability of the battery can be obtained. Large quantities of nano-sized pores inside the material can store lithium, which is beneficial to the enhancement of the batteries' energy densities. In addition, the relatively high packing density can greatly increase the specific energy in volume. All the above merits comprehensively improve the properties of the secondary lithium batteries.

Besides the utilization in secondary lithium batteries, the spherical or ellipsoidal pyrolyzed hard carbon in the present invention can be used as active material for solid lubricants owing to its smooth surface, narrowly distributed range of particle size and self-lubricating property similar to graphite. Moreover, since the spherical or ellipsoidal pyrolyzed hard carbon is isotropy and there are sp³ carbon atoms within the material, the structure of the material is stable, the frication endurance, thermal and chemical stability are high. Therefore, the pyrolyzed hard carbon of the invention can be used as raw material for industrial brush or electrode. Due to its spherical characteristics, the spherical or ellipsoidal pyrolyzed hard carbon in the present invention is also used as alloy additive in metallurgy. Taking advantages of its fine and uniform particle size, the spherical or ellipsoidal pyrolyzed hard carbon of present invention can be used to prepare composite material with high flexibility. Since the precursors in the present invention are all natural and recyclable, the preparation process based on hydrothermal method is harmless to the environment and human beings. The large quantities of nanosized pores within the material result in excellent adsorption capability, thus makes the spherical or ellipsoidal pyrolyzed hard carbon in the present invention as an excellent candidate to be used as hydrogen storage material, carrier for catalysts, sorbents for toxicant or for special uses, decolorizer in food production, or raw material for synthetic human organs. So the spherical or ellipsoidal pyrolyzed hard carbon in the present invention can be widely used in various fields, such as energy storage, metallurgy, chemical industry, light industry, mechanism, food, communication, environment preservation, biomedicine material and national defense, etc.

As described above, the merits of the present invention lie in: The conventional preparation technique of hard carbon directly from solid carbonization has been shifted in the present invention. In the present invention, the precursor is dewatered in liquid state for carbonization. Because the fluidity of organic molecules is greatly increased at high pressure (2˜1000 atm), the ordered arrangement of molecules can be enhanced. The addition of organic addictives which have molding and dispersion effects helps the obtained intermediate have very regular spherical or ellipsoidal morphology, and also result in narrowly distributed range of particle size, rendering the material the property of easy-to-control. Further high temperature carbonization process after dewatering does not change the spherical or ellipsoidal morphology, so the screening process can be avoided.

### BRIEF DESCRIPTION OF THE ILLUSTRATIONS

In the illustrations:

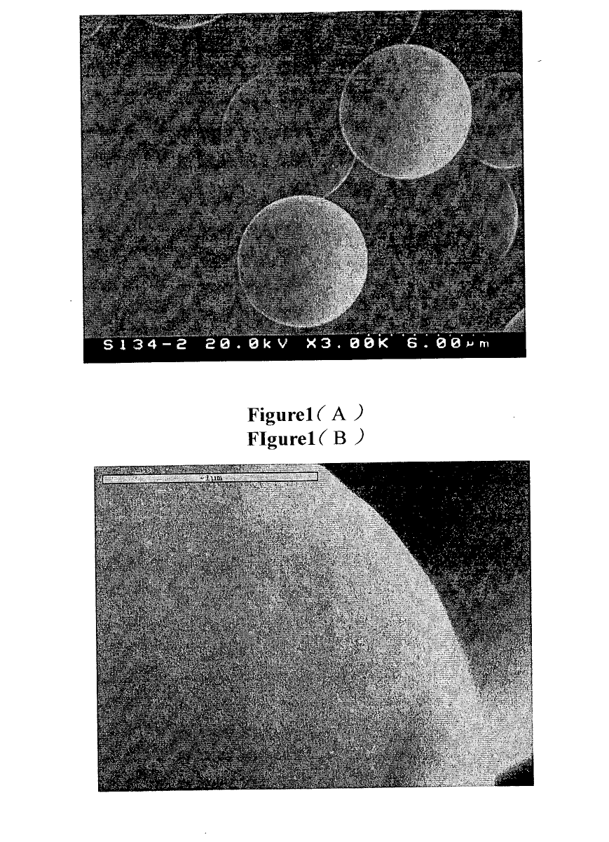

FIG. 1 is the scanning electron microscope (SEM) images of the spherical hard carbon of the present invention in EXAMPLE 1, of which the precursor is sucrose. The magnification of (A) is 20000 folds, and the magnification of (B) is 90000 folds.

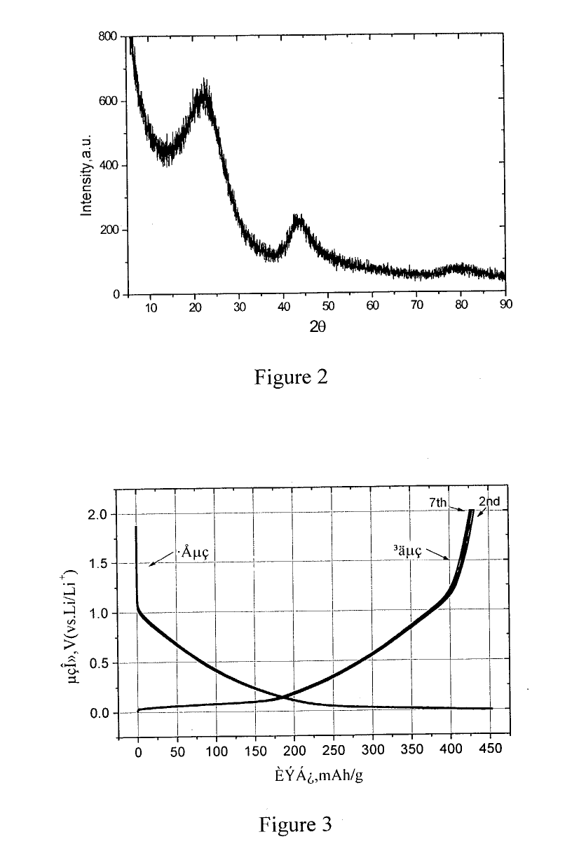

FIG. 2 is the x-ray diffraction pattern of the spherical hard carbon of the present invention in EXAMPLE 1, of which the precursor is sucrose.

FIG. 3 is the charge/discharge voltage profiles of the negative electrode material for lithium ion batteries, of which the spherical hard carbon of the present invention in EXAMPLE 1 is used as negative electrode material and the precursor is sucrose

### EXAMPLE

In order to indicate more fully the nature and utility of this invention, the following examples are set forth, it being understood that these examples are presented as illustrative only and are not intended to limit the scope of the invention.

### Example 1

Preparation of spherical hard carbon material: 400 grams of sucrose is firstly dissolved in 600 milliliters of water to form homogeneous dispersion system. Organic additive tetraethylammonium hydroxide (TEAOH) is added into above solution to a final concentration of 1 molar per liter, and then followed with stirring. The mixture is put into a 1-liter autoclave (the same autoclave is used in following examples) with stirring. The rotate speed is 800 rounds per minute, and the fill rate is 70 percent. The autoclave is heated to 200 degrees centigrade with a heating rate of 30 degrees centigrade per hour. After 24 hours' duration at 200 degrees centigrade, the autoclave is cooled to ambient temperature with a cooling rate of 1 degree centigrade per hour. The obtained powder is washed by distilled water till the filtrates being transparent. After drying at 120 degrees centigrade, we can obtain the intermediate.

Then the intermediate is put into a tube furnace (1000 millimeters in length, 60 millimeters in diameter, the same tube furnace is used in following examples). Under the protection of nitrogen atmosphere, the tube furnace is heated to 1200 degrees centigrade with a heating rate of 300 degrees centigrade per hour. The flow rate of nitrogen is 25 milliliters per minute. After 6 hours' duration at 1200 degrees centigrade, the furnace is cooled to ambient temperature with a cooling rate of 20 degrees centigrade per hour. The final obtained powder is the spherical pyrolyzed hard carbon material. The scanning electron microscope images of the spherical hard carbon at different magnifications are shown in FIG. 1(A), (B). The x-ray diffraction (XRD) pattern is indicated in FIG. 2. It is clear that the obtained material has very regular spherical morphology and narrow particle size distribution.

Using XRD method, the d₀₀₂ is measured to be 0.392 nanometers, La is 4.9 nanometers, Lc is 2.8 nanometers, and the average particle size is about 10 micrometers. Using BET method, the specific surface area is about 120 square meters per gram, the diameter of the nanopores is about 0.6˜5 nanometers, the real density is 1.78 grams per cubic centimeter, and the tap density is 1.37 grams per cubic centimeter (tap for 500 times).

In order to indicate the utility of the spherical pyrolyzed hard carbon in the present invention as negative electrode material for lithium ion batteries, a lithium-testing cell is designed. The electrolyte is consisted of 1 molar per liter of lithium hexafluorophosphate (LiPF₆) dissolved in a 50/50 volume percent mixture of ethylene carbonate (EC) and dimethyl carbonate (DEC).

Using the spherical hard carbon (denoted as HCS1) as negative electrode material, the preparation of the electrode is described as follows: HCS1 carbon powder and conducting reagent carbon black are firstly mixed with polyvinylidene fluoride and then dissolved in N-methyl pyrrolidone in ambient temperature and pressure. The above slurry is coated on current collector copper foil substrates. The obtained film has a thickness of about 120 micrometers. After drying at 150 degrees centigrade, the film is pressed under the pressure of 20 kilograms per square centimeter and then continues drying at 150 degrees centigrade for another 12 hours. The contents of HCS1, carbon black and polyvinylidene chloride in the dried electrode film are 86, 5, 9 in weight percent, respectively. Lastly, circular pieces with area of 1 square centimeter are cut from the electrode film to act as carbon negative electrode.

Lithium foil with thickness of 0.4 millimeters and area of 1 square centimeter is used as counter electrode. The testing cell is assembled in argon-filled glove box. The charge/discharge cycling experiments are carried out on a charger controlled by computer. The current density is 0.1 milliamperes per square centimeter. The voltage range during the charge/discharge cycles is from 0.00 volt to 2.0 volts. The charge/discharge voltage profiles are indicated in FIG. 3. It is can be seen that the reversible capacity is 430 milliampere hour per gram, which is much higher than that of the commercial negative electrode material for lithium ion batteries, 330 milliampere hour per gram. The cyclic performance of the testing is satisfactory.

### Example 2

2000 grams of sucrose is firstly dissolved in 400 milliliters of water to form homogeneous dispersion system. Organic additive glycerol is added into above solution to a final concentration of 1 molar per liter. The above mixture is put into an autoclave and the fill rate is 50 percent. The other conditions and processes to obtain the intermediate are the same as EXAMPLE 1, except the heating duration at 200 degrees centigrade is extended to 36 hours.

Then the intermediate is put into a tube furnace. Under argon atmosphere, the tube furnace is heated to 900 degrees centigrade with a heating rate of 300 degrees centigrade per hour. The flow rate of argon is 200 milliliters per minute. After 6 hours' duration at 900 degrees centigrade, the furnace is cooled to ambient temperature with a cooling rate of 100 degrees centigrade per hour. The final obtained powder is the spherical pyrolyzed hard carbon material in EXAMPLE 1. The x-ray diffraction (XRD) pattern and morphology of the product are similar to sample HCS1. Using XRD method, the d₀₀₂ is measured to be 0.396 nanometers, La is 4.5 nanometers, Lc is 2.2 nanometers, and the average particle size is about 100 micrometers. Using BET method, the specific surface area is about 2.1 square meters per gram, the diameter of the nanopores is about 0.6˜0.8 nanometers, the real density is 1.77 grams per cubic centimeter, and the tap density is 1.37 grams per cubic centimeter. Content of the impurity is about 1 percent in weight of the material.

### Example 3

400 grams of sucrose is firstly dissolved in 850 milliliters of water to form homogeneous dispersion system. Organic additive N,N-diethylethanamine is added into above solution to a final concentration of 1 molar per liter. In addition, 138 grams of zinc chloride, as activation reagent, is also dissolved in the above dispersion system. The above mixture is put into an autoclave and the fill rate is 95 percent. The other conditions and processes to obtain the intermediate are the same as EXAMPLE 1, except the heating duration at 200 degrees centigrade is extended to 36 hours.

Then the intermediate is put into a tube furnace. Under argon atmosphere, the tube furnace is heated to 900 degrees centigrade with a heating rate of 300 degrees centigrade per hour. The flow rate of argon is 200 milliliters per minute. After 6 hours' duration at 900 degrees centigrade, the furnace is cooled to ambient temperature with a cooling rate of 100 degrees centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.42 nanometers, La is 4.0 nanometers, Lc is 2.8 nanometers, and the average particle size is about 20 micrometers. Using BET method, the specific surface area is about 1250 square meters per gram, the diameter of the nanopores is about 0.6˜35 nanometers, the real density is 1.65 grams per cubic centimeter, and the tap density is 0.73 grams per cubic centimeter.

### Example 4

Mixture of 100 grams of sucrose, 50 grams of glucose and 50 grams of starch is firstly dissolved in 700 milliliters of water to form homogeneous dispersion system. Organic additive triethanolamine is added into above solution to a final concentration of 0.5 molar per liter. After stirring, the above mixture is put into an autoclave and the fill rate is 80 percent. The other conditions and processes to obtain the intermediate are the same as EXAMPLE 1, except the heating rate is increased to 600 degrees centigrade per hour.

Then the intermediate is put into a tube furnace. Under nitrogen atmosphere, the tube furnace is heated to 600 degrees centigrade with a heating rate of 300 degrees centigrade per hour. The flow rate of nitrogen is 0.5 milliliters per minute. After 48 hours' duration at 600 degrees centigrade, the furnace is cooled to ambient temperature with a cooling rate of 1 degree centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.445 nanometers, La is 2.1 nanometers, Lc is 1.8 nanometers, and the average particle size is about 6 micrometers. Using BET method, the specific surface area is about 410 square meters per gram, the diameter of the nanopores is about 0.6˜12 nanometers, the real density is 1.69 grams per cubic centimeter, and the tap density is 1.31 grams per cubic centimeter.

### Example 5

5 grams of sucrose is firstly dissolved in 300 milliliters of water to form homogeneous dispersion system. Organic additive tri-n-propylamine is added into above solution to a final concentration of 0.1 molar per liter. After stirring, the above mixture is put into an autoclave and the fill rate is 30 percent. The stirring speed of blender is 1500 rounds per minute during heating of the autoclave. The other conditions and processes to obtain the intermediate are the same as EXAMPLE 1, except there is no heating step involved.

Then the intermediate is put into a tube furnace. Under nitrogen atmosphere, the tube furnace is heated to 1000 degrees centigrade with a heating rate of 300 degrees centigrade per hour. The flow rate of nitrogen is 25 milliliters per minute. After 1 hour's duration at 1000 degrees centigrade, the furnace is cooled to ambient temperature with a cooling rate of 1500 degree centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.392 nanometers, La is 4.3 nanometers, Lc is 2.0 nanometers, and the average particle size is about 0.05 micrometers. Using BET method, the specific surface area is about 530 square meters per gram, the diameter of the nanopores is about 0.345˜2 nanometers, the real density is 1.66 grams per cubic centimeter, and the tap density is 1.09 grams per cubic centimeter.

### Example 6

150 grams of sucrose is firstly dissolved in 800 milliliters of water to form homogeneous dispersion system. The above mixture is then put into an autoclave and the fill rate is 85 percent. The heating rate of the autoclave is 6 degrees centigrade per hour. The other conditions and processes to obtain the intermediate are the same as EXAMPLE 1, except the heating duration at 200 degrees is extended to 48 hours

Then the intermediate is put into a tube furnace. Under nitrogen atmosphere, the tube furnace is heated to 3000 degrees centigrade with a heating rate of 90 degrees centigrade per hour. The flow rate of nitrogen is 100 milliliters per minute. After 4 hours' duration at 3000 degrees centigrade, the furnace is cooled to ambient temperature with a cooling rate of 200 degree centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.345 nanometers, La is 6.1 nanometers, Lc is 20 nanometers, and the average particle size is about 5 micrometers. Using BET method, the specific surface area is about 120 square meters per gram, the diameter of the nanopores is about 0.5˜0.9 nanometers, the real density is 2.18 grams per cubic centimeter, and the tap density is 1.43 grams per cubic centimeter.

### Example 7

600 grams of phenolic resin is firstly dissolved in ethanol to form 500 milliliters of homogeneous dispersion system. Organic additive N,N-dimethylbenzylamine is added into above solution to a final concentration of 0.2 molar per liter with stirring. The above mixture is put into an autoclave and the fill rate is 50 percent. The autoclave is then heated to 300 degrees centigrade with a heating rate of 50 degrees centigrade per hour. After 10 hours' duration at 300 degrees centigrade, the autoclave is cooled to ambient temperature with a cooling rate of 5 degree centigrade per hour. The obtained powder is washed with ethanol till the filtrates being transparent. After drying at 120 degrees centigrade, we can obtain the intermediate.

Then the intermediate is put into a tube furnace. Under vacuum condition (the vacuum degree is 380 millimeter Hg), the tube furnace is heated to 1050 degrees centigrade with a heating rate of 30 degrees centigrade per hour. After 8 hours' duration at 1050 degrees centigrade, the furnace is cooled to ambient temperature with a cooling rate of 50 degree centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.373 nanometers, La is 3.1 nanometers, Lc is 2.8 nanometers, and the average particle size is about 35 micrometers. Using BET method, the specific surface area is about 100 square meters per gram, the diameter of the nanopores is about 0.8˜20 nanometers, the real density is 1.89 grams per cubic centimeter, and the tap density is 1.42 grams per cubic centimeter.

### Example 8

800 grams of phenolic resin is firstly dissolved in mixture of ethanol and acetone (volume ratio of 1:1) to form 750 milliliters of homogeneous dispersion system. Organic additive n-Dipropylamine is added into above solution to a final concentration of 0.5 molar per liter with stirring. The above mixture is put into an autoclave and the fill rate is 75 percent. The other conditions and processes to obtain the intermediate are the same as EXAMPLE 1, except the heating duration at 200 degrees is reduced to 5 hours

Then the intermediate is put into a tube furnace. Under vacuum condition (the vacuum degree is 10 millimeter Hg), the tube furnace is heated to 850 degrees centigrade with a heating rate of 60 degrees centigrade per hour. After 8 hours' duration at 850 degrees centigrade, the furnace is cooled to ambient temperature with a cooling rate of 50 degree centigrade per hour. The final obtained powder is just the spherical pyrolyzed hard carbon material. The x-ray diffraction (XRD) pattern and morphology of the product are similar to sample HCS1. Using XRD method, the d₀₀₂ is measured to be 0.381 nanometers, La is 2.9 nanometers, Lc is 2.1 nanometers, and the average particle size is about 5 micrometers. Using BET method, the specific surface area is about 450 square meters per gram, the diameter of the nanopores is about 0.5˜3.5 nanometers, the real density is 1.77 grams per cubic centimeter, and the tap density is 1.26 grams per cubic centimeter.

### Example 9

100 grams of polyacrylonitrile is firstly dissolved in N,N-dimethylformamide to form 600 milliliters of homogeneous dispersion system. Organic additive pivalic amine is added into above solution to a final concentration of 0.05 molar per liter with stirring. The above mixture is put into an autoclave and the fill rate is 60 percent. The autoclave is then heated to 250 degrees centigrade with a heating rate of 100 degrees centigrade per hour. After 10 hours' duration at 250 degrees centigrade, the autoclave is cooled to ambient temperature with a cooling rate of 50 degree centigrade per hour. The obtained powder is washed by 75 percent ethanol aqueous solution till the filtrates being transparent. After drying at 120 degrees centigrade, we can obtain the intermediate.

Then the intermediate is put into a tube furnace. Under argon atmosphere, the tube furnace is heated to 1200 degrees centigrade with a heating rate of 60 degrees centigrade per hour. The argon flow rate is 5 milliliters per minute. After 4 hours' duration at 1200 degrees centigrade, the furnace is cooled to ambient temperature with a cooling rate of 3000 degree centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.379 nanometers, La is 3.6 nanometers, Lc is 2.4 nanometers, and the average particle size is about 12 micrometers. Using BET method, the specific surface area is about 190 square meters per gram, the diameter of the nanopores is about 0.8˜50 nanometers, the real density is 1.72 grams per cubic centimeter, and the tap density is 1.21 grams per cubic centimeter.

### Example 10

180 grams of polyacrylonitrile is firstly dissolved in N,N-dimethylformamide to form 450 milliliters of homogeneous dispersion system. Organic additive tert-butylamine is added into above solution to a final concentration of 0.1 molar per liter with stirring. The above mixture is put into an autoclave and the fill rate is 45 percent. The other conditions and processes to obtain the intermediate are the same as EXAMPLE 9.

Then the intermediate is put into a tube furnace. Under nitrogen atmosphere, the tube furnace is heated to 1200 degrees centigrade with a heating rate of 60 degrees centigrade per hour. The argon flow rate is 25 milliliters per minute. After 8 hours' duration at 1200 degrees centigrade, the furnace is cooled to ambient temperature with a cooling rate of 1000 degree centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.371 nanometers, La is 4.2 nanometers, Lc is 2.8 nanometers, and the average particle size is about 25 micrometers. Using BET method, the specific surface area is about 104 square meters per gram, the diameter of the nanopores is about 0.6˜5 nanometers, the real density is 1.86 grams per cubic centimeter, and the tap density is 1.37 grams per cubic centimeter.

### Example 11

250 grams of starch is firstly dissolved in distilled water to form 500 milliliters of homogeneous dispersion system. Organic additive 3-methylpiperidine is added into above solution to a final concentration of 0.1 molar per liter. The above mixture is put into an autoclave and the fill rate is 50 percent. The autoclave is then heated to 250 degrees centigrade with a heating rate of 50 degrees centigrade per hour. After 1 hour's duration at 250 degrees centigrade, the autoclave is cooled to room temperature with a cooling rate of 10 degree centigrade per hour. The obtained powder is washed by distilled water till the filtrates being transparent. After drying at 120 degrees centigrade, we can obtain the intermediate.

Then the intermediate is put into a tube furnace. Under hydrogen atmosphere, the tube furnace is heated to 900 degrees centigrade with a heat rate of 120 degrees centigrade per hour. The hydrogen flow rate is 25 milliliters per minute. After 1 hour's duration at 900 degrees centigrade, the furnace is cooled to ambient temperature with a cooling rate of 100 degree centigrade per hour. The final obtained powder is just the spherical pyrolyzed hard carbon material. The x-ray diffraction (XRD) pattern and morphology of the product are similar to sample HCS1. Using XRD method, the d₀₀₂ is measured to be 0.366 nanometers, La is 2.8 nanometers, Lc is 1.9 nanometers, and the average particle size is about 80 micrometers. Using BET method, the specific surface area is about 450 square meters per gram, the diameter of the nanopores is about 0.6˜1.2 nanometers, the real density is 1.88 grams per cubic centimeter, and the tap density is 1.45 grams per cubic centimeter.

### Example 12

600 grams of starch is firstly dissolved in distilled water to form 600 milliliters of homogeneous dispersion system. Organic additive ethylenediamine is added into above solution to a final concentration of 0.01 molar per liter with stirring. The above mixture is put into an autoclave and the fill rate is 65 percent. The autoclave is then heated to 250 degrees centigrade with a heating rate of 300 degrees centigrade per hour. The other conditions and processes to obtain the intermediate are the same as EXAMPLE 11.

Then the intermediate is put into a tube furnace. Under hydrogen atmosphere, the tube furnace is heated to 1200 degrees centigrade with a heating rate of 120 degrees centigrade per hour. The hydrogen flow rate is 25 milliliters per minute. After 1 hour's duration at 1200 degrees centigrade, the furnace is cooled to room temperature with a cooling rate of 100 degree centigrade per hour. The obtained powder is further soaked in solution of potassium hydroxide (100 grams of KOH dissolved in water to form 200 milliliters of aqueous solution) for one day. Then under hydrogen atmosphere, the soaked powder is again heated to 900 degrees centigrade with a heating rate of 60 degrees centigrade per hour. The hydrogen flow rate is 25 milliliters per minute. After 1 hours' duration at 900 degrees centigrade, the furnace is cooled to room temperature with a cooling rate of 100 degree centigrade per hour. The final obtained powder is the activated spherical pyrolyzed hard carbon material. The x-ray diffraction (XRD) pattern and morphology of the product are similar to sample HCS1. Using XRD method, the d₀₀₂ is measured to be 0.389 nanometers, La is 3.1 nanometers, Lc is 2.2 nanometers, and the average particle size is about 4 micrometers. Using BET method, the specific surface area is about 1320 square meters per gram, the diameter of the nanopores is about 0.5˜15 nanometers, the real density is 1.78 grams per cubic centimeter, and the tap density is 0.84 grams per cubic centimeter.

### Example 13

1200 grams of cellulose acetate is firstly dissolved in distilled water to form 800 milliliters of homogeneous dispersion system. Organic additive dibutylamine is added into above solution to a final concentration of 0.1 molar per liter with stirring. The above mixture is put into an autoclave and the fill rate is 80 percent. The autoclave is then heated to 255 degrees centigrade with a heating rate of 50 degrees centigrade per hour. After 10 hours' duration at 255 degrees centigrade, the autoclave is cooled to ambient temperature with a cooling rate of 10 degree centigrade per hour. The obtained powder is washed by distilled water till the filtrates being transparent. After drying at 120 degrees centigrade, we can obtain the intermediate.

Then the intermediate is put into a tube furnace. Under nitrogen atmosphere, the tube furnace is heated to 900 degrees centigrade with a heating rate of 60 degrees centigrade per hour. The nitrogen flow rate is 25 milliliters per minute. After 6 hours' duration at 900 degrees centigrade, the furnace is cooled to ambient temperature with a cooling rate of 200 degree centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.382 nanometers, La is 2.6 nanometers, Lc is 1.8 nanometers, and the average particle size is about 30 micrometers. Using BET method, the specific surface area is about 210 square meters per gram, the diameter of the nanopores is about 0.5˜8 nanometers, the real density is 1.69 grams per cubic centimeter, and the tap density is 1.38 grams per cubic centimeter.

### Example 14

Mixture of 300 grams of cellulose acetate and 100 grams of phosphoric acid is firstly dissolved in distilled water to form 600 milliliters of homogeneous dispersion system. Add organic additive 2-imidazolinone into above solution to a final concentration of 0.05 molar per liter with stirring. The above mixture is put into an autoclave and the fill rate is 60 percent. The other conditions and processes to obtain the intermediate are the same as EXAMPLE 13.

Then the intermediate is put into a tube furnace. Under carbon dioxide atmosphere, the tube furnace is heated to 1000 degrees centigrade with a heating rate of 300 degrees centigrade per hour. The nitrogen flow rate is 25 milliliters per minute. After 16 hours' duration at 1000 degrees centigrade, the furnace is cooled to ambient temperature with a cooling rate of 20 degree centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.450 nanometers, La is 1 nanometer, Lc is 1.2 nanometers, and the average particle size is about 1 micrometers. Using BET method, the specific surface area is about 4000 square meters per gram, the diameter of the nanopores is about 0.4˜25 nanometers, the real density is 0.84 grams per cubic centimeter, and the tap density is 0.35 grams per cubic centimeter.

### Example 15

Mixture of 200 grams of epoxy and 100 grams of phthalic anhydride is firstly dissolved in ethanol to form 500 milliliters of homogeneous dispersion system. Add organic additive tetrapropylamine into above solution to a final concentration of 0.1 molar per liter with stirring. The above mixture is put into an autoclave and the fill rate is 50 percent. The autoclave is then heated to 180 degrees centigrade with a heating rate of 200 degrees centigrade per hour. After 8 hours' duration at 180 degrees centigrade, the autoclave is cooled to ambient temperature with a cooling rate of 50 degree centigrade per hour. The obtained powder is washed by ethanol till the filtrates being transparent. After drying at 120 degrees centigrade, we can obtain the intermediate.

Then the intermediate is put into a tube furnace. Under vacuum condition (the vacuum degree is 350 millimeter Hg), the tube furnace is heated to 1050 degrees centigrade with a heating rate of 300 degrees centigrade per hour. After 8 hours' duration at 1050 degrees centigrade, the furnace is cooled to ambient temperature with a cooling rate of 50 degree centigrade per hour. The final obtained powder is just the spherical pyrolyzed hard carbon material. The x-ray diffraction (XRD) pattern and morphology of the product are similar to sample HCS1. Using XRD method, the d₀₀₂ is measured to be 0.359 nanometers, La is 2.7 nanometers, Lc is 2.1 nanometers, and the average particle size is about 8 micrometers with a distribution of 1˜12 micrometers. Using BET method, the specific surface area is about 210 square meters per gram, the diameter of the nanopores is about 0.8˜1.8 nanometers, the real density is 1.67 grams per cubic centimeter, and the tap density is 1.28 grams per cubic centimeter.

### Example 16

Mixture of 720 grams of epoxy and 360 grams of solidifying reagent phthalic anhydride is firstly dissolved in ethanol to form 900 milliliters of homogeneous dispersion system. Organic additive 4-methylpiperidine is added into above solution to a final concentration of 0.2 molar per liter. The above mixture is put into an autoclave and the fill rate is 90 percent. The autoclave is then heated to 150 degrees centigrade with a heating rate of 200 degrees centigrade per hour. The other conditions and processes to obtain the intermediate are the same as EXAMPLE 15.

Then the intermediate is put into a tube furnace. Under vacuum condition (the vacuum degree is 0.001 millimeter Hg), the tube furnace is heated to 850 degrees centigrade with a heating rate of 300 degrees centigrade per hour. After 1 hour's duration at 850 degrees centigrade, the furnace is cooled to room temperature with a cooling rate of 50 degree centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.365 nanometers, La is 2.1 nanometers, Lc is 1.4 nanometers, and the average particle size is about 20 micrometers. Using BET method, the specific surface area is about 150 square meters per gram, the diameter of the nanopores is about 0.8˜2.5 nanometers, the real density is 1.82 grams per cubic centimeter, and the tap density is 1.41 grams per cubic centimeter.

### Example 17

Mixture of 40 grams of polyformaldehyde, 120 grams of phenol and 320 grams of epoxy is firstly dissolved in ethanol to form 800 milliliters of homogeneous dispersion system. Organic additive dipentylamine is added into above solution to a final concentration of 0.05 molar per liter with stirring. The above mixture is put into an autoclave and the fill rate is 80 percent. The autoclave is then heated to 200 degrees centigrade with a heating rate of 50 degrees centigrade per hour. After 10 hours' duration at 200 degrees centigrade, the autoclave is cooled to ambient temperature with a cooling rate of 20 degree centigrade per hour. The obtained powder is washed first by distilled water and then by ethanol till the filtrates being transparent. After drying at 120 degrees centigrade, we can obtain the intermediate.

Then the intermediate is put into a tube furnace. Under argon atmosphere, the tube furnace is heated to 1000 degrees centigrade with a heating rate of 60 degrees centigrade per hour. The argon flow rate is 25 milliliters per minute. After 8 hours' duration at 1000 degrees centigrade, the furnace is cooled to ambient temperature with a cooling rate of 200 degree centigrade per hour. The final obtained powder is the spherical pyrolyzed hard carbon material. The x-ray diffraction (XRD) pattern and morphology of the product are similar to sample HCS1. Using XRD method, the d₀₀₂ is measured to be 0.379 nanometers, La is 3.1 nanometers, Lc is 2.2 nanometers, and the average particle size is about 12 micrometers with a distribution of 5˜20 micrometers. Using BET method, the specific surface area is about 3.1 square meters per gram, the diameter of the nanopores is about 0.6˜3 nanometers, the real density is 1.69 grams per cubic centimeter, and the tap density is 1.18 grams per cubic centimeter.

### Example 18

Mixture of 75 grams of polyformaldehyde, 225 grams of phenol and 450 grams of epoxy is firstly dissolved in ethanol to form 750 milliliters of homogeneous dispersion system. Organic additive 2-methylpyridine is added into above solution to a final concentration of 0.1 molar per liter. The above mixture is put into an autoclave and the fill rate is 75 percent. The other conditions and processes to obtain the intermediate are the same as EXAMPLE 17, except the duration at 200 degrees centigrade is reduced to 6 hours.

Then the intermediate is put into a tube furnace. Under argon atmosphere, the tube furnace is heated to 1000 degrees centigrade with a heating rate of 60 degrees centigrade per hour. The argon flow rate is 25 milliliters per minute. After 8 hours' duration at 1000 degrees centigrade, the furnace is cooled to ambient temperature with a cooling rate of 200 degree centigrade per hour. The final obtained powder is just the spherical pyrolyzed hard carbon material. The x-ray diffraction (XRD) pattern and morphology of the product are similar to sample HCS1. Using XRD method, the d₀₀₂ is measured to be 0.374 nanometers, La is 3.1 nanometers, Lc is 2.1 nanometers, and the average particle size is about 45 micrometers with a distribution of 15˜50 micrometers. Using BET method, the specific surface area is about 1.0 square meters per gram, the diameter of the nanopores is about 0.6˜2.2 nanometers, the real density is 1.71 grams per cubic centimeter, and the tap density is 1.35 grams per cubic centimeter.

1. A kind of pyrolyzed hard carbon in the present invention, which presents the following characteristics: the described pyrolyzed hard carbon material is a kind of spherule or ellipsoid with smooth surface, particle size of 0.05˜100 μm in diameter, and surface roughness not more than 0.5 percent of the particle size; the specific surface Brunauer-Emmett-Teller area (BET area) is between 1 and 4000 m²/g; there are micropores and mesopores within the material, and pore size is 0.3˜50 nm; the d₀₀₂ is 0.345˜0.45 nm and the values of Lc and La are 1˜20 nm from X-ray diffraction (XRD) measurement; the real density is 0.8˜2.2 g/cm³ and tap density is 0.35˜1.5 g/cm³; and the amount of elements beside carbon is not more than 10 percent in weight within the material.

2. A method to prepare pyrolyzed hard carbon material described in claim 1, which includes the following steps:
(1) Preparation of homogeneous dispersion system. The precursor for hard carbon synthesis is firstly dispersed in solvents to form homogeneous dispersion system with a concentration of 0.05˜10 molar per liter. Of which
The solvents include water, ethanol, acetone, N,N-dimethylformamide and other regular organic solvents;
The precursors for synthesis of pyrolyzed hard carbon include glucose, sucrose, fructose, cellulose, starch and phenolic resin, polyacrylonitrile, mixture of epoxy and solidifying reagent phthalic anhydride, or mixture of epoxy, polyformaldehyde and phenol;
Glucose, sucrose, fructose, cellulose, starch or the mixture of any above precursors in random ratio, mixed with water to form homogeneous dispersion system with a concentration of 0.05˜10 molar per liter; or another precursor, phenolic resin, polyacrylonitrile, mixture of epoxy and solidifying reagent phthalic anhydride, or mixture of epoxy, polyformaldehyde and phenol, one of which is mixed with the regular organic solvents, such as, ethanol, acetone, N,N-dimethylformamide or the mixture of any above organic solvents in random ratio, to form homogeneous dispersion system with a concentration of 0.05˜10M.
For the above described mixture of epoxy and phthalic anhydride, the content of epoxy is not less than 25 percent in weight; for the above described mixture of epoxy, polyformaldehyde and phenol, the content of epoxy is no less than 25 percent in weight, the content of phenol is not more than 10 percent in weight, and the rest is polyformaldehyde.
(2) Dewatering in liquid state. The homogeneous dispersion system prepared in step (1) is put into pressure vessel with a fill rate of 30˜95 percent. The sealed pressure vessel is heated to a final temperature of 150˜300 degrees centigrade with a heating rate of 30˜600 degrees centigrade per hour. The mixture should be maintained at the final temperature for 0˜48 hours. Mechanical stirring is optional with a rotate speed of 0˜1500 rounds per minute.
(3) Washing and drying. After cooling to ambient temperature with a cooling rate of 1˜3000 degrees centigrade per hour, the intermediate is taken out from the pressure vessel and washed with water, ethanol or its aqueous solution at random concentration, then filtrated to the filtrates being transparent. The filtrated intermediate is dried at 50˜200 degrees centigrade to remove the water.
(4) High temperature carbonization. After drying, the intermediate is placed in furnace either under the protection of inert or hydrogen atmosphere with a flow rate of 0.5˜200 milliliter per minute, or under vacuum degree of 0.001˜380 mmHg; and the intermediate is carbonized with a heating rate of 30˜300 degrees centigrade per hour. After reaching the final temperature of 600˜3000 degrees centigrade, the intermediate is maintained at constant temperature for 0˜48 hours, and then cooled to ambient temperature with a cooling rate of 1˜3000 degrees centigrade per hour. Finally, we can obtain the spherical or ellipsoidal pyrolyzed hard carbon.

3. A method based on claim 2 to prepare pyrolyzed hard carbon material characterized in that it includes a step of adding 0˜5 molar per liter of organic additives into the homogeneous dispersion system. These organic additives include: glycol, glycerol, tetraethylammonium hydroxide, n-Dipropylamine, tri-n-propylamine, N,N-diethylethanamine, triethanolamine, dibutylamine, pivalic amine, dipentylamine, isopropylamine, tert-butylamine, ethylenediamine, N,N-dimethylbenzylamine, dicyclohexylamine, N,N-dimethylpropanolamine, tetrapropylamine, quaterary ammonium salt, choline, 2-methylpyridine, 3-methylpiperidine, 4-methylpiperidine or 2-imidazolinone.

4. A method based on claim 2 or 3 to prepare pyrolyzed hard carbon material characterized in that it includes a step of adding activation additives in any step of steps (1), (3), or (4). The activation additives include: zinc chloride, potassium sulfide, potassium sulfate, sodium sulfate, sodium sulfide, phosphoric acid, potassium hydroxide, sodium hydroxide or lithium hydroxide. The weight ratio of the additive to the precursor is 0.1˜10.

5. A method based on claim 2 or 3 to prepare pyrolyzed hard carbon material characterized in that it includes an activation step through gas activation process. For the purpose, either the protection gas is displaced by activation gas during or after step (4), or the activation gas flows together with protection gas during step (4). The activation gases include carbon dioxide, water vapor, air or oxygen, of which the flow rate is 0.5˜200 milliliters per minute.

6. Application of pyrolyzed hard carbon material described in claim 1, wherein the described pyrolyzed hard carbon material is used as negative electrode material for secondary lithium batteries, hydrogen storage material, active material of solid lubricants, raw material of industrial brush or electrode, alloy additives in metallurgy, composite material with high flexibility, carrier for catalysts, sorbents for toxicants or for special uses, decolorizer for food production, or raw material for synthetic human organs.
